(19) United States
(12) Patent Application Publication
(10) Pub. No.: US 2024/0375277 A1
(43) Pub. Date: Nov. 14, 2024

(54) Robotic Multi-Pick Detection

(71) Applicant: Staples, Inc., Framingham, MA (US)

(72) Inventors: Sai Bharadwaj Appakaya, Tampa, FL (US); Swetha Pasham, Tampa, FL (US); Aum Patel, Tampa, FL (US); Harsha Amba, Tampa, FL (US)

(21) Appl. No.: 18/659,678

(22) Filed: May 9, 2024

Related U.S. Application Data
(60) Provisional application No. 63/502,099, filed on May 14, 2023.

(51) Int. Cl. B25J 9/16; B25J 9/00

(52) U.S. Cl. CPC B25J 9/1653; B25J 9/0096; B25J 9/163; B25J 9/1697

(57) ABSTRACT

A system may capture image data of one or more items at a scanning area using one or more cameras. The system may determine one or more thresholds for the image data using one or more first dimensions of a set of items and may filter the image data using the one or more thresholds. The system may estimate one or more second dimensions of the one or more items based on the filtered image data, and the system may identify a first item from among the one or more items by comparing the estimated one or more second dimensions of the one or more items with the one or more first dimensions of the set of items.

### BACKGROUND

This application relates to warehouse fulfillment systems. For example, this application relates to an efficient, automated system for identifying items and/or the quantity thereof using optical sensors.

Existing systems for fulfilling orders pick items into cartons one-by-one, often using human pickers that seek out items in a warehouse and then place them into shipping cartons. Human-based systems result in errors, fatigue, and increased task completion time.

While using a robot to pick items may reduce human fatigue and error, such systems present their own challenges, such as the difficulty or inconsistency of robots in grasping objects, especially from groups of multiple objects. Accordingly, robots may grasp multiple or incorrect objects or perform other errors, which results in incorrect order picking, storage, inventory checking, or other operations.

Furthermore, attempts to address these robotic limitations have been expensive, not adaptable, bulky, or inefficient. For example, previous systems for identifying items required items to be in a specific orientation, for example, so that a bar code could be read. Other systems required significant processing time and/or a blank background in order to accurately identify items, so they were both slow and not robust. Other systems attempt to identify any item in the world but are not accurate to distinguish between similar items or multiple items, nor are they fast enough to be used in an industrial application.

### SUMMARY

A robotic multi-pick detection system can be configured to perform particular operations or actions by virtue of having software, firmware, hardware, or a combination of them installed on the system that in operation causes or cause the system to perform the actions. In some aspects, the techniques described herein relate to a computer-implemented method including: capturing, by one or more processors and using one or more cameras, image data of one or more items at a scanning area; determining, by the one or more processors, one or more thresholds for the image data using one or more first dimensions of a set of items; filtering, by the one or more processors, the image data using the one or more thresholds; estimating, by the one or more processors, one or more second dimensions of the one or more items based on the filtered image data; and identifying, by the one or more processors, a first item from among the one or more items by comparing the estimated one or more second dimensions of the one or more items with the one or more first dimensions of the set of items.

In some aspects, the techniques described herein relate to a computer-implemented method, further including: determining, by the one or more processors, that the one or more items include a plurality of items based on the estimated one or more second dimensions and the one or more first dimensions.

In some aspects, the techniques described herein relate to a computer-implemented method, further including: receiving, by the one or more processors, a software trigger, the software trigger indicating when a robotic arm is holding the one or more items at the scanning area; and responsive to receiving the software trigger, capturing the image data by a plurality of cameras, each of the plurality of cameras being placed at a different angle to the scanning area.

In some aspects, the techniques described herein relate to a computer-implemented method, further including: retrieving, by the one or more processors using a robotic arm, the one or more items from a mobile storage unit, the mobile storage unit holding the set of items; and positioning, by the one or more processors using the robotic arm, the one or more items at the scanning area.

In some aspects, the techniques described herein relate to a computer-implemented method, further including: instructing, by the one or more processors, a robotic arm to retrieve a defined item of the set of items from a mobile storage unit; determining, by the one or more processors, that the first item does not match the defined item; and instructing, by the one or more processors, the robotic arm to replace the first item in the mobile storage unit.

In some aspects, the techniques described herein relate to a computer-implemented method, further including: instructing, by the one or more processors, a robotic arm to retrieve a defined item of the set of items from a mobile storage unit; determining, by the one or more processors, that the first item does match the defined item; and instructing, by the one or more processors, the robotic arm to release the first item to a shipping carton.

In some aspects, the techniques described herein relate to a computer-implemented method, further including: transporting, by the one or more processors using an automated guided vehicle, the mobile storage unit holding the set of items to an item delivery area associated with the one or more cameras; and determining the one or more first dimensions describing the set of items based on an identity of the mobile storage unit.

In some aspects, the techniques described herein relate to a computer-implemented method, wherein capturing the image data of the one or more items at the scanning area includes: capturing two images from two different angles using the one or more cameras.

In some aspects, the techniques described herein relate to a computer-implemented method, wherein estimating the one or more second dimensions of the one or more items includes: generating, by the one or more processors, a point cloud using the two images, each of the two images being captured using a stereoscopic camera.

In some aspects, the techniques described herein relate to a computer-implemented method, wherein filtering the image data using the one or more thresholds includes: excluding, by the one or more processors, one or more objects in the image data based on the one or more objects being external to the scanning area of the image data defined by the one or more thresholds.

In some aspects, the techniques described herein relate to a system including: a robotic arm adapted to hold one or more items at a defined scanning area; a frame holding two or more cameras at a defined angle to the defined scanning area; and one or more processors executing instructions that cause the one or more processors to perform operations including: processing image data captured using the two or more cameras; and performing one or more of determining an identity of the one or more items and determining whether the one or more items include a plurality of items.

In some aspects, the techniques described herein relate to a system, wherein: each of the two or more cameras include a stereoscopic camera; and the image data includes at least two stereoscopic images.

In some aspects, the techniques described herein relate to a system, wherein the frame includes one or more horizontal members that allow the two or more cameras to be adjusted along two horizontal axes.

In some aspects, the techniques described herein relate to a system, further including: a chute below the defined scanning area, the robotic arm being configured to drop the one or more items through the chute.

In some aspects, the techniques described herein relate to a system, further including: an item delivery area from which the robotic arm is configured to grasp the one or more items; and an item receiving area to which the robotic arm is configured to place the one or more items, the one or more items passing through the chute to the item receiving area responsive to the one or more processors determining that that the one or more items include a single item.

In some aspects, the techniques described herein relate to a system, wherein the operations further include: determining, by the one or more processors, one or more thresholds for the image data using one or more first dimensions of a defined set of items; and filtering, by the one or more processors, the image data using the one or more thresholds.

In some aspects, the techniques described herein relate to a system, wherein the operations further include: estimating, by the one or more processors, one or more second dimensions of the one or more items based on the filtered image data; and identifying, by the one or more processors, a first item from among the one or more items by comparing the estimated one or more second dimensions of the one or more items with the one or more first dimensions of the defined set of items.

In some aspects, the techniques described herein relate to a system, wherein the operations further include: determining, by the one or more processors, that the one or more items include the plurality of items based on the estimated one or more second dimensions and the one or more first dimensions.

In some aspects, the techniques described herein relate to a system, wherein the operations further include: retrieving, by the one or more processors using the robotic arm, the one or more items from a mobile storage unit, the mobile storage unit holding a set of items; and positioning, by the one or more processors using the robotic arm, the one or more items at the defined scanning area.

In some aspects, the techniques described herein relate to a system, wherein the operations further include: instructing, by the one or more processors, the robotic arm to retrieve a defined item of a set of items from a mobile storage unit; determining, by the one or more processors, that the one or more items do not match the defined item; and instructing, by the one or more processors, the robotic arm to replace the one or more items in the mobile storage unit.

In some aspects, the techniques described herein relate to a method including: positioning, by a robotic arm, one or more items at a defined location; capturing three-dimensional image data of the one or more items at the defined location using a plurality of stereoscopic cameras; determining one or more thresholds for image processing using expected dimensions of the one or more items; applying filtering using the one or more thresholds to the three-dimensional image data; estimating dimensions of the one or more items using the filtered three-dimensional image data; and determining that the one or more items include a plurality of items based on the estimated dimensions and the expected dimensions of the one or more items.

Other implementations of one or more of these aspects include corresponding systems, apparatus, and computer programs, configured to perform the actions of the methods, encoded on computer storage devices.

It should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 depicts an example system and data communication flow for implementing an automated robotic multi-pick detection system.

FIG. 2 illustrates an example layout of a portion of a fulfillment center used in the automated robotic multi-pick detection system.

FIGS. 3A-3D illustrate example implementations of a multi-item detection or picking station.

FIGS. 4A and 4B illustrate images, which may represent views of a left camera and a right camera.

FIG. 5 is a flowchart of an example method for item identification and/or multi-item detection.

FIG. 6 is a block diagram illustrating an example computing system.

### DESCRIPTION

The technology described herein relates to an automated system comprising various software and hardware devices, for example, an automated robotic replenishment system. The technology may include beneficial configurations, operations, features, and interactions. Among other benefits, the technology described herein improves upon that described in the Background Section. For instance, the technology provides robotic devices, systems, methods, and other aspects that can more efficiently process goods (e.g., items or items in a distribution facility). For example, the technology described herein may be applied in various robotic contexts in which a quick identification of an item and/or a quantity thereof is needed.

Additionally, the technology described herein may result in significantly shorter processing time than previous systems and provide increased adaptability to varied or irregular contexts. For instance, the technology described herein may be used with different or varying lighting, background, or other circumstances while accurately identifying items. Previous systems were deficient in these areas, and they were slow and not robust or adaptable.

Unlike previous systems that merely match a captured image with a database image (e.g., outputting a simple true or false result), the technology described herein may identify an item from various angles, positions, and/or backgrounds. In some instances, the technology may determine and limit possible items that may be identified based on certain criteria in addition to data captured using one or more optical sensors. Accordingly, implementations of the technologies described herein may be fast enough to be suitable for industrial applications unlike technologies that generically attempt to identify any item, but the technologies herein may also be accurate enough to distinguish between similar items. The technologies may be more adaptable than technologies that only identify a single item against a consistent background. Accordingly, these technologies may be fast and accurate enough to avoid delays or errors in an automated warehouse environment.

The robotic order fulfilment implemented in the fulfillment center may use a robotic arm or other handling mechanism that picks SKUs (stock keeping units or types of items) from a (e.g., one of the multiple) pick location around it. In some implementations, for purposes of accurate counting or item placement, the work-flow architecture may require a robotic arm to pick up one only one SKU out from a bin and drop it into a carton that is presented in front using a conveyor system. For instance, the technology described herein may verify that only a single item is picked into a shipping carton, so that a correct quantity may be sent to a customer.

Robotic arms may incorrectly pick up multiple items due to various reasons, such as replenishment issues, suction cup targeting the SKUs over the hole cut-outs made for hanging them in stores, etc. The technology, including the detection application 622, may use single lens, three-dimensional (3D) (e.g., stereoscopic, time of flight, lidar, etc.), or stereoscopic vision cameras or other sensors to identify the items and/or multi-picks that happen sporadically and may transmit an alert (e.g., a WES 102, WMS 104, or human interface system 108) to indicate that those cartons get manually checked (e.g., by flagging the carton to be checked by quality control).

In some implementations, the technology may use a robotic arm 140 and/or various other devices that handle items. For instance, a fulfillment center may use storage units, conveyors, or other devices that hold or move various types of items and from which the items may be picked to fulfill orders (or otherwise processed), such as by removing items from the storage units and placing them into shipping boxes. In other implementations, the items may be moved from pallets into storage units or otherwise robotically handled, for instance.

In some implementations, the technology may provide integration, coordination, and control of various systems to intelligently move items and reduce human interaction, which increased speed and accuracy.

In some instances, the technology may include various computing devices or controllers coupled with equipment, such as the robotic arm(s), optical sensors or cameras 142, AGV(s) 114, other equipment 144, sensors (e.g., optical sensors, scanners, etc.) human interface system(s) 108, and other devices. In some implementations, the components may communicate with each other directly, for instance, via a network or communication bus. In some implementations, a central control system, such as a warehouse management system (WMS) 104 or other system may receive signals, perform computations, and issue commands to other devices.

The robotic arm(s) 140, camera(s) 142, and other devices, along with operations and other features, are described in further detail below. They may be communicatively coupled with one or more computing devices at a station, which may be controlled using or in association with computer logic, such as the detection application 622 described in further detail below.

These and other technologies described herein provide numerous benefits, such as those described above, quickly and automatedly identifying items or duplicates thereof, increasing operating hours, decreasing fatigue, and allowing the technology to scale rapidly, for example, over previous, manual methods. The technology may allow items to be automatically counted (e.g., into one or multiple mobile storage units) without a human agent having to manually count them, which is often inaccurate.

Features of the technology described herein can be integrated into any logistics system, dispatch system, warehouse execution system (WES 102), warehouse management system (WMS 104), a robot execution server (REX 118), etc., to coordinate the operations of various systems, information, and devices in a fulfillment system. The technology described herein may provide a fully or partially automated system that provides redundancy, reduces the quantity of operations, and provides many other benefits described herein. The technology beneficially improves productivity and throughput, increases asset utilization, and lowers cycle time and labor costs. These benefits, in turn, lead to shorter delivery times and result in significant time and resource savings along with reduced error rates.

The technology may, based on an identification of an item, automate numerous operations, such as the coordinated interaction of otherwise un-associated systems thereby providing the noted benefits, among others. The system may include various levels of control, for example, by providing system-level and/or device-level identification, processing, and/or control. It should be noted that these operations are provided as an illustrative example and many other operations and features are within the scope of the present disclosure.

With reference to the figures, reference numbers may be used to refer to components found in any of the figures, regardless of whether those reference numbers are shown in the figure being described. Further, where a reference number includes a letter referring to one of multiple similar components (e.g., component 000a, 000b, and 000n), the reference number may be used without the letter to refer to one or all of the similar components.

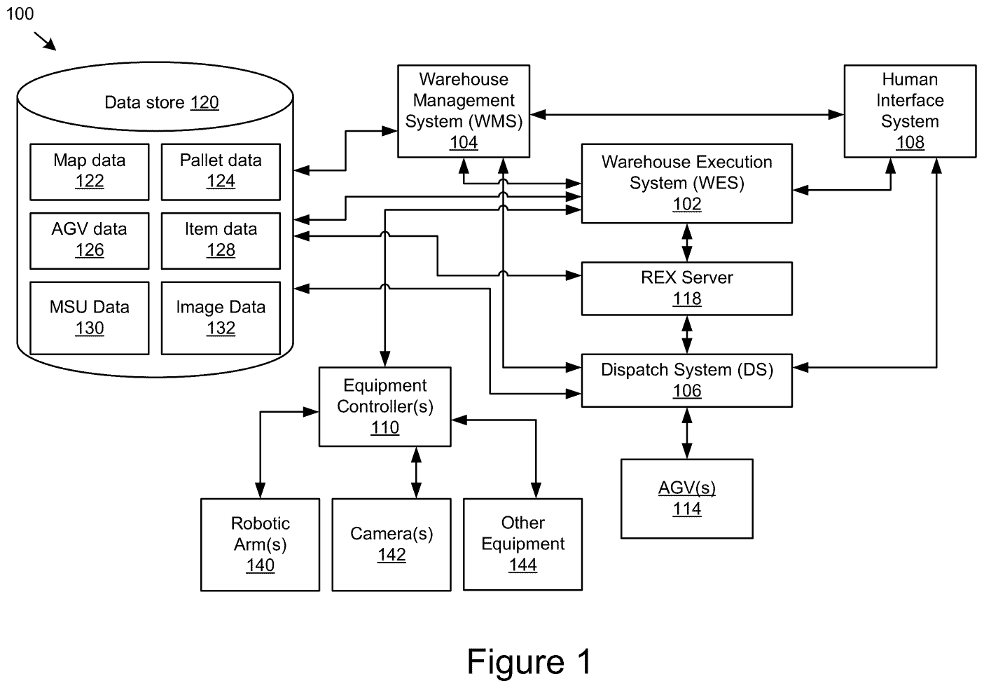

FIG. 1 depicts an example system 100 and data communication flow for implementing an automated robotic multi-pick detection system. The system 100 may include a warehouse execution system (WES) 102, which may be coupled to equipment controller(s) 110, a warehouse management system (WMS) 104, a data store 120 storing various data, a human interface system 108 (e.g., pick-to-voice, pick-to-light, graphical user interface(s), etc.), a robot execution server (REX) 118, a dispatch system 106, and other systems. For instance, the system 100 may include robotic arm(s) 140 or other item positioning systems, optical sensors or cameras 142, and/or other equipment 144, such as conveyors, robots, or other devices.

The WES 102 may, in some implementations, include one or more hardware and/or virtual servers programmed to perform operations, acts, and/or functionality described herein. For instance, the components of the WES 102 may comprise software routines storable in one or more non-transitory memory devices and executable by one or more computer processors of the WES 102 to carry out operations, acts, and/or functionality described herein. In further implementations, these routines, or a portion thereof, may be embodied in electrical hardware that is operable to carry out the operations, acts, and/or functionality described herein.

For example, the WES 102 may be communicatively coupled with scanner(s), carton conveyor(s), item conveyor(s), diverter(s), robotic arms 140, camera(s) 142, and other equipment either directly or via the equipment controller(s) 110, which may be programmable logic controllers (e.g., conveyor controllers, conveyor scanner controllers, automated induction equipment controllers, other warehouse equipment controllers, or other computing devices for controlling equipment).

In some implementations, the WES 102 may receive, process, and transmit data to control software and hardware interactions, for example, by consolidating and controlling information across systems, as described herein. For instance, the WES 102 may serve as a decision point or control software that processes data streams for receiving data, processing the data, instructing devices, and other computations, as noted herein. For example, the WES 102 may communicate with equipment controller(s) 110 and/or other systems to receive scan data, move items (e.g., using a conveyance device 240), control a robotic arm 140, move mobile storage units 224, or other operations. One or more of these operations may be performed via communication with various equipment of the system 100, as described in further detail herein. Accordingly, the WES 102 may provide unified communication that coordinates various systems.

The WES 102 and/or WMS 104 (together or separately) may communicate with various other systems and devices to perform its operations, as described herein, such as equipment controller(s) 110 and equipment. The WES 102 or WMS 104 may communicate with equipment or a human-interface system 108, which may provide operations for picking items, for instance.

The other equipment 144 may include a station (e.g., where items are placed on a conveyor belt), box erectors, label applicators, scanners, picking equipment, or other devices for inducting or moving items, mobile storage units, cartons, or other objects in the system; scanners that may include optical, radio, or other scanners or sensors that scan items, containers, totes, mobile storage units 224, or cartons to identify them; conveyors that may include one or more conveyor belts or other devices that convey objects (e.g., items, mobile storage units 224, cartons, or other objects), for instance, as described herein. Other equipment 144 may include various other devices, such as label applicators, carton-closing equipment, control systems, printers, actuators, motors, or various other devices.

The REX server 118 may, in some implementations, include one or more hardware and/or virtual servers programmed to perform operations, acts, and/or functionality described herein. The REX server 118 may generate a schedule that defines the route for an AGV 114. For a given AGV 114, the REX server 118 may generate an AGV 114 schedule and transmit it to the dispatch system 106, which in turn deploys an AGV 114 according to the schedule or instruction, for instance. In some implementations, the dispatch system 106 instructs the AGV 114 to proceed through one or more areas of the distribution facility according to the schedule/instruction. The schedule of each of the AGVs 114 may be coordinated such that an optimal flow can be achieved.

In some implementations, the REX server 118 may include or may communicate with a routing engine, which may route AGVs 114 and/or objects (e.g., items, mobile storage units 224, etc.) in a fulfillment center.

The dispatch system 106 may be electronically communicatively coupled to a plurality of automated guided vehicles (AGVs) 114. In some implementations, the dispatch system 106, or elements thereof, may be integrated with or communicatively coupled with the REX server 118. The dispatch system 106 includes hardware and software configured to dispatch the AGVs 114 and is coupled for communication the components of the system 100 to receive instructions and provide data. The dispatch system 106 may calculate operations to execute the task considering resources and constraints.

The AGVs 114 may be robotic vehicles including drive units providing motive force for moving the AGVs 114 (and, in some instances, items, storage units, etc.), guidance systems for determining position of the AGVs 114 within the distribution facility, and equipment for carrying items. Some AGVs 114 may be attached to, include, or carry carts, which, in turn, carry items or storage units. Although not illustrated in the figures herein, in some implementations, an AGV 114 may include a robotic arm 140, camera(s) 142, or other components.

The WMS 104 may, in some implementations, include one or more hardware and/or virtual servers or software routines storable in one or more non-transitory memory devices and executable by one or more processors to perform operations, acts, and/or functionality described herein. The WMS 104 may be configured to store and maintain data in the data store 120. In some implementations, the WMS 104 may be configured to communicate with the WES 102, the human interface system 108, dispatch system 106, and/or other systems in real time, in batches, as requested by these components, etc. For example, the WMS 104 may receive data from an e-commerce or other server, process the data, and update various data in the data store 120 based on the order data. Similarly, the WMS 104 may detect and update inventory and other data.

It should be noted that operations described herein in reference to the WMS 104 may be performed by other devices or by other components of the system 100. Similarly, it should be noted that the operations described in reference the WMS 104 and the other components of the system 100 may be distributed or shifted among the components of the system without departing from the scope of this disclosure. For instance, some operations described in reference to the WMS 104 may be performed by the equipment controller(s) 110 or REX server 118, or some operations described in reference to the equipment controller(s) 110, REX server 118, robotic arm(s) 140, camera(s) 142, other equipment 144, etc., may be performed by the WMS 104 or WES 102.

A detection application 622 or its functions may be executed on a single computing device (e.g., the WMS 104, WES 102, equipment controller(s) 110, etc.), or in conjunction across multiple devices. For example, a detection application 622 may be executed on an equipment controller 110/computer for a picking station. It may issue instructions to a computing device of a robotic arm, issue instructions and receive data from camera(s) 142, access data on the datastore 120, or communicate with other components of the system. For instance, the WES 102 may instruct an AGV 114, conveyor 240, human agent, etc., to transport a tote holding a plurality of items to a receiving area at a picking station. It may also transmit a message to an equipment controller 110 instructing it to perform and verify a pick operation. The message may include data describing a location of the tote, the set of items (e.g., SKUs, dimensions, physical attributes, etc.) in the tote, pick tasks or sequence, or other data. The message may cause the equipment controller 110 to control the robotic arm 140 and/or camera(s) 142, or they may be controlled directly. As can be seen, various other arrangements for controlling the components and executing the features and operations herein are possible.

The human interface system 108 may, in some implementations, include one or more hardware and/or virtual servers or software routines storable in one or more non-transitory memory devices and executable by one or more processors to perform operations, acts, and/or functionality described herein. The human interface system 108 may provide instructions and/or receive data (e.g., scan data, user input, confirmations), for example, from human agents or operators (e.g., using barcode scanners, NFC, RFID or radio-frequency identification chips, or other sensors or input methods), as described in further detail below. An example human interface system 108 may include audio, illumination, or a graphical user interface system that receives inputs and/or provides instructions to human agents. The human interface system 108 may be configured to communicate the instructions with the WES 102, WMS 104, or other components of the system in real time, in batches, as requested by the components of the system, etc.

The human interface system 108 may include or communicate with a client device to receive scan data from the client device based on a user scanning a barcode or other identifier of an item, conveyance device 240, tote, etc. The human interface system 108 may provide instructions to users indicating to place certain items, totes, containers, mobile storage units 224, etc., at certain locations, remedy errors or exceptions, or perform other actions. For instance, the human interface system 108 may instruct a user to dump a container of items into a certain tote/conveyance device 240 for a certain picking station (e.g., 302), remedy an error at a station or AGV 114, or perform other actions.

The data store 120 is an information source for storing and providing access to data. The data stored by the data store 120 may be organized and queried using various criteria including any type of data stored by it. The data store 120 may include data tables, databases, or other organized collections of data. An example of the types of data stored by the data store 120 may include, but is not limited to map data 122, pallet data 124, AGV 114 data 126, item data 128, MSU (mobile storage unit 224) data, image data 132, or other data. In some instances, the data store 120 may also include system attributes, sensor data, etc.

The data store 120 may be included in the WES 102, WMS 104, REX server 118, or in another computing system and/or storage system distinct from but coupled to or accessible by the WES 102, WMS 104, REX server 118, or other components of the system 100. The WES 102, WMS 104, human interface system 108, REX server 118, and/or dispatch system 106, for example, may store and maintain data in the data store 120. The data store 120 can include one or more non-transitory computer-readable mediums for storing the data. In some implementations, the data store 120 may store data associated with a database management system (DBMS) operable on a computing system. For example, the DBMS could include a structured query language (SQL) DBMS, a NoSQL DMBS, various combinations thereof, etc. In some instances, the DBMS may store data in multi-dimensional tables comprised of rows and columns, and manipulate (e.g., insert, query, update and/or delete) rows of data using programmatic operations.

The map data 122 may include data reflecting the two- or three-dimensional layout of the facility including example locations of storage units, picking stations (e.g., 302), container receiving areas/spaces, mobile storage unit 224 receiving area/spaces, staging area(s) 206, equipment, storage shelving units, items, AGVs 114, conveyors, etc. Map data 122 may indicate the attributes of the distribution facility, including attributes of zones/areas of a warehouse. For example, attributes of zones may include the number, quantity, and location of shelving units or bays, storage units, items, guidance system locators or markers, etc.

The pallet data 124 may include data about pallets in or inbound to a fulfillment center. For instance, a pallet may have an identification number and attributes, such as the items or item types (e.g., SKUs or SKU attributes) on that pallet, an identification marker (e.g., a barcode, QR™ code, RFID tag, etc.) by which the pallet may be identified using a scan or other input, its location, priority, size, or other information.

The AGV data 126 may describe the state of an AGV 114, such as operational state, health, location, battery life, storage capacity, objects (e.g., items, mobile storage units 224, totes, pallets, etc.) being carried, cartons, whether a picker is assigned to it, etc.

The item data 128 may describe items in a distribution facility. The item data 128 may include unique identifiers or SKUs for the items, the item volume (e.g., the total amount picked in given window (e.g., in an hour, day, etc.)), the item velocity (e.g., number of different times item picked in given window (e.g., per hour, day etc.), the location of the items within the distribution facility (aisle, shelf, shelf position, mobile storage unit 224, mobile storage unit partition, tote, conveyance device 240, pallet, etc.), other attributes of the item (e.g., size, description, weight, quantity of items in a package, color, quantity of packages in a container, etc.), item inventory, or mapping of items to storage units, orders, conveyor locations, picking stations 302, pallets, totes, etc. In some implementations, the item data 128 may include the quantity of particular items a storage unit contains, the current location of a storage unit, a storage location of items and/or storage units, and other data. For instance, the item data 128 may include visual aspects (e.g., color, shape, symbols, etc.), dimensions, labels, QR codes, identifying markers, etc., that may be used by the WES 102, WMS 104, or equipment controller(s) 110, etc., to identify items, for example, based on a scan of an item.

In some implementations, the item data may include identifications and/or attributes of sets of items, for example, in a modular storage unit, in an order, on a pallet, carried by an AGV, carried by a conveyor 240a, 240b, or 240c, etc. The item data may include item dimensions, such as the maximum or minimum height, volume, width, length, etc., of an item. In some instances, the item data may also identify a general shape (e.g., associated with the dimensions) of an item, for example, whether an item is cylindrical, cuboid, triangular, etc.

The MSU data 130 may include information about mobile storage units 224 and/or containers in the system, such as a unique identifier or license plate number for each mobile storage unit 224 or container, a mobile storage unit 224 or container type, the zones a mobile storage unit 224 will visit, the current or assigned location of a mobile storage unit 224, and the priority for the mobile storage unit 224. The MSU data 130 may include a list indicating the items, item types, and/or the quantity of items a mobile storage unit 224 (or a partition thereof) contains or should contain (e.g., it's maximum or assigned capacity). The MSU data 130 may include size or configuration of a mobile storage unit 224, associated robotic arm 140 or station 302, or other details.

The image data 132 may include various data pertaining to the camera(s) 142 or other optical sensors, such as the state of each camera, camera angles, camera positions, which cameras are associated with which robotic-arms or other positioning equipment, etc. In some instances, the image data 132 may also describe the camera, such as its position, angle to a scanning location, field of view, resolution, or otherwise. In some cases, the image data 132 may include images captured by the cameras, etc., as described below.

The components of the system 100 may be coupled to exchange data via wireless and/or wired data connections. The connections may be made via direct data connections and/or a computer network. The computer network may comprise any number of networks and/or types of networks, such as wide area networks, local area networks, virtual private networks, cellular networks, close or micro proximity networks (e.g., Bluetooth, NFC, etc.), etc. In some implementations, one or more of these components may be coupled via a data communications bus.

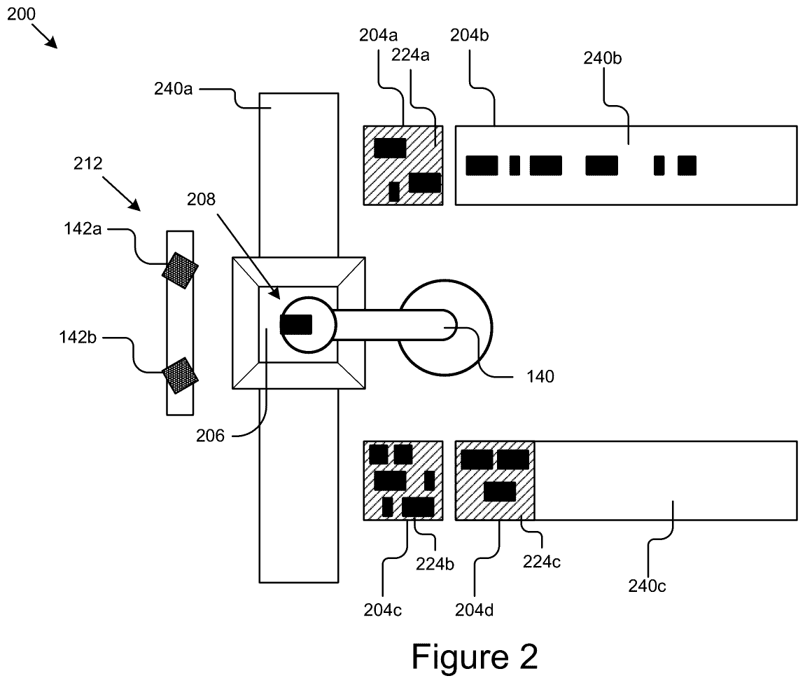

FIG. 2 illustrates an example layout 200 of a portion of a fulfillment center used in the automated robotic multi-pick detection system. It should be understood that various facilities may include different configurations. For instance, a fulfillment center, distribution facility, or other location may use some or all of the aspects of the example layout 200 to replenish the stock of mobile storage units 224. It should be noted that other configurations, components, or layouts are possible and contemplated herein, and the example of FIG. 2 is provided by way of illustration.

The example layout 200 and components of FIG. 2 may allow automated operations, as described in further detail below. Example features of the layout 200 provide various benefits, for example, as described above. The WMS 104 may use multiple parallel processes and/or equipment to intelligently schedule, spit, and coordinate tasks. In some implementations, the system 100 may coordinate multiple robotic arms and other equipment to fulfill a single order or to balance a load for multiple orders across the system. For instance, multiple robotic arms 140 may be placed along a conveyor 240a to place items into a carton as the carton passes by the robotic arms 140 on the conveyor 240a to receive one or more picks from each of multiple robotic arms 140. Other implementations are possible and contemplated.

It should be noted that the layout 200 is merely provided as an illustrative example of how the technology described herein could be applied and that other layouts, configurations, and uses may be used.

Depending on the implementation, the example layout 200 may include one or more robotic arms 140 or other positioning equipment, item delivery areas 204a, 204b, 204c, and 204d, item receiving area(s) 206, and/or other components. It should be noted that although certain numbers or configurations of these components are illustrated, additional, fewer, or different components are possible and contemplated.

The item delivery areas 204 may be any areas or devices that deliver items to a positioning system, such as a robotic arm 140. For instance, the item delivery areas 204 may be positioned around a robotic arm 140, as illustrated. For instance, items may be delivered to a robotic arm 140 in a tote (e.g., a modular storage unit 224c) on a conveyor 240c (e.g., as at 204d), directly on a conveyor 240b (e.g., as at 204b), in a tote 224a or 224b (e.g., by a human or AGV 114, as at 204a and 204c) or otherwise. For example, a robotic arm 140 may pick an item from one of the areas 204.

The robotic arm 140 may be adapted to pick up or otherwise move (e.g., by conveyor, sorter, crane, etc.) one or more items and place the one or more items at a scanning location 208 and/or item receiving area 206. For instance, a robotic arm 140 may include a suction or grasping mechanism that grasps items.

The robotic arm 140 and/or camera(s) 142 may be controlled by an equipment controller 110 or may have its own computing unit that receives instructions (e.g., from the WES 102, WMS 104, or equipment controller 110) instructing the robotic arm 140 to perform certain tasks (e.g., move an item(s) from a defined location, grasp items, drop items, etc.). In response, the robotic arm's controller may determine the specific movements or operations for the robotic arm 140, camera, or other components of the station. The station or layout 200 may include other sensors, scanners, or other inputs that communicate with the computing unit or another component of the system 100, for instance, as described herein.

For example, a robotic arm 140 may pick an item from one of the locations 204, move it to a defined location, which may be a scan location 208. In some instances, the scan location 208 may be above (adjacent to, etc.) an item delivery area 204, an item receiving area 206, or otherwise. The scan location may be a defined location relative to the cameras 142a and 142b, such as a common focal length of the cameras. The scan location 208 may be at the same height or plane as the cameras, although other implementations or angles are possible. For example, as illustrated, the robotic arm 140 may move an item from an item delivery area 204 to a scan location 208 where the camera(s) 142 scan it and, based on a result of the processing herein, deposit it at the item receiving area 206. In some implementations, the robotic arm 140 may position an item to be scanned at a common focal point of the camera(s) 142 and planar to them. This point may be above a chute, at an item receiving area, above an item delivery area, or otherwise.

A given item delivery location 204, as illustrated in the example, may hold a single item type that may be picked up by the robotic arm 140, and the technology may determine whether the robotic arm 140 has grasped multiple of that item type using the technologies described herein (e.g., where the item type is known or not known before scanning). In some instances, a given item delivery location 204 may hold multiple items (e.g., in mobile storage unit 224) of various types (e.g., SKUs) that may be picked up by a robotic arm 140 or other apparatus (e.g., a crane, diverter, etc.) and which items may be identified using the technologies described herein.

An item receiving area 206 may have various configurations, such as a flat surface on which a shipping container rests, a cart onto which items are picked, a conveyor belt 240a, a chute, a tote/mobile storage unit, or other configuration. For instance, as illustrated in the example of FIG. 2, an item receiving area 206 may include sloped walls and an aperture, which form a chute through which items may pass as they are dropped by a robotic arm 140. The item(s), passing through the chute, may enter a shipping carton or tote, for example, held on a conveyor 240a. For example, once an item is identified as being a particular item and/or a single copy of the item, it may be dropped by the robotic arm 140 into the chute (e.g., 308) and carton. It should be noted that the example implementations described herein may be used in various contexts in addition or alternative to the example illustrated.

In some implementations, the layout 200 may include a scanning apparatus 212 that holds one or more cameras 142 at a defined position relative to the scanning location 208. As described in further detail below, the defined position and/or angle of the camera(s) 142 may be known, along with the scanning location 208, so that the relative sizes, distances, angles, etc., may be used to measure item dimensions or otherwise.

The scanning apparatus 212 may hold one or more camera(s) 142 at a set position/angle. For instance, as noted below, the scanning apparatus 212 may include a frame that allows two cameras (e.g., single lens, 3D, stereoscopic, binocular, etc.) to be mounted thereto. The frame may be adjustable in the XY plane to allow the cameras 142 to be moved toward/away from the scanning location 208 as well as change their angles to the scanning location. In some instances, the frame may also be vertically adjustable. Although example measurements for these dimensions are provided elsewhere herein, it should be noted that these may vary depending on focal length of the cameras 142, range of sizes of items to be scanned, capabilities of the cameras, or other factors.

As described below, in some implementations, two 3D cameras may be used, although other implementations are possible and contemplated. The cameras may each be a 3D camera (e.g., with multiple optical sensors lenses, etc., with a range finder or time of flight sensor, with a lidar device, etc.). For example, one or both of the cameras 142 may be capable of determining a distance, dimension, and/or shape of an item, although other implementations, such as where a 2D camera is used, are possible and contemplated herein. The camera(s) 142 may be offset from each other and angled toward the scanning location 208, for example, to capture items from different perspectives or angles, as noted below.

It should be noted that while certain movements, interactions, paths, locations, and devices are illustrated, other implementations are possible and contemplated herein. The examples described or illustrated in reference to FIG. 2 are provided as illustrative examples.

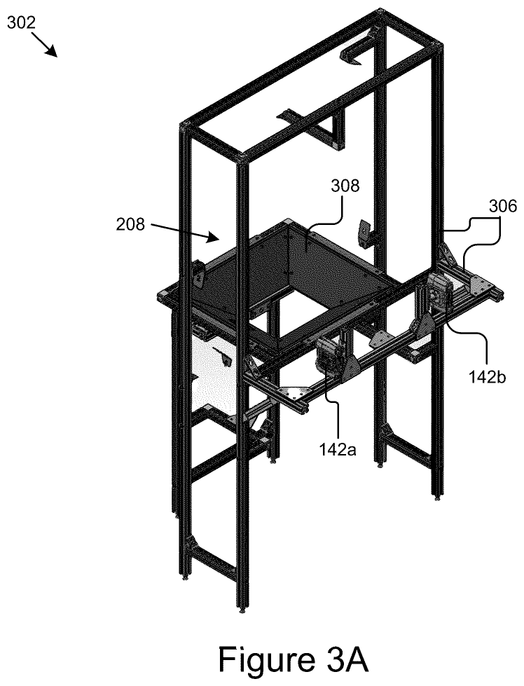

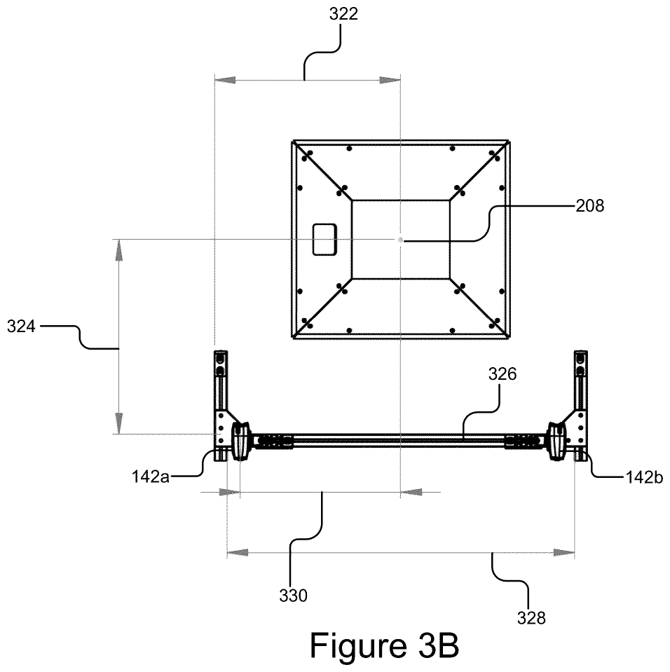

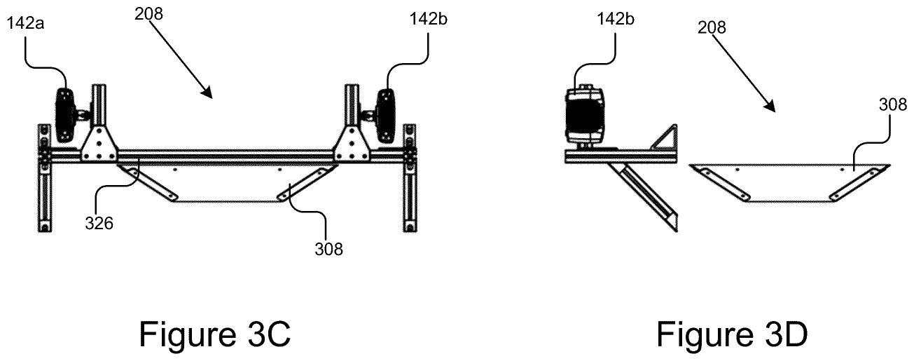

FIGS. 3A-3D illustrate example implementations of a multi-item detection station 302. For example, FIG. 3A illustrates a perspective view, FIG. 3B illustrates a partial top-down view with example dimensions, FIG. 3C illustrates a partial front view, and FIG. 3D illustrates a partial side view. Although other configurations are possible, an illustrated example configuration is provided.

An objective of a detection application 622 and the multi-item detection station 302 is to capture images of an item or of the robotic arm 140 (not shown in FIGS. 3A-3D) when it holds onto the item, for instance, before dropping the item into a carton. These images may be processed by the detection application 622 to estimate the dimensions of the item which may be used to verify whether the arm 140 picked one item or multiple items, or whether the correct item was picked.

In some implementations, a computing device may be present in or connected with the station 302 and may communicate with the WES 102, WMS 104, equipment controller 110, or other components of the system 100, as described elsewhere herein. For instance, a computing device coupled to the station 302 may perform image processing, communication, control, receive commands, or perform other operations, such as those described elsewhere herein. Depending on the implementation, the station's computing device may communicate via JSON (JavaScript Object Notation) over a TCP (Transmission Control Protocol) socket or another protocol with other components of the system 100 to perform the operations herein, for example.

In some implementations, the station 302 may include one or more frames 306 that hold camera(s) 142a and 142b or other structures at a defined position. For instance, the frame 306 may hold a chute 308, camera(s) 142, or other devices at defined positions relative to a positioning device, such as a robotic arm 140 (not shown in FIGS. 3A-3D). For instance, the robotic arm 140 may be programmed to hold an item at a scanning location 208, which may be directly above a chute 308 or at another defined location. The robotic arm 140 may pause with the item at the scanning location 208 for an image, may wait for a communication confirming the identity or quantity of the scanned item, or may automatically continuously move the item (e.g., through the chute 308 and into an item receiving area 206).

The frame(s) 306 may be constructed from aluminum extrusions or other members that allow the cameras 142 to be positioned, for instance, along the horizontal extrusions (e.g., by simply loosening and tightening a bolt, handle, or quick release), so that the cameras 142 can adaptably be moved closer (e.g., for scanning smaller items) or farther (e.g., for scanning larger items) based on item size or camera attributes (e.g., focal length, resolution, etc.). For example, a frame member 326 may slide horizontally along a first axis and one or more cameras 142 may slide along the frame member 326 in a second horizontal axis to allow the camera(s) 142 to be adjusted along at two horizontal axes. The camera(s) 142 may also be rotatable on the frame member 326 to allow their angle to be defined toward the scanning area 208.

Similarly, the camera(s) 142 may be slid or positioned horizontally along a cross bar, as illustrated in the example, so that the angle between the camera(s) 142 and/or the angle to the scanning location 208 may be adapted.

For example, FIG. 3B illustrates a top-down view of an example station 302 in which example dimensions are shown. The angles may vary based on sizes, variations in shape, or other attributes of items to be scanned. For example, the camera(s) 142 may be positioned close enough that they capture some of the same surface of an item in order to coordinate dimensions between them, but they may be positioned far enough apart that different sides of the item are captured to better estimate a 3D size of an object, as noted below.

As illustrated in the example of FIG. 3B, a width 322 of the station between a frame edge and a scanning location 208 may be 595 millimeters, although this distance may be varied widely depending on item dimensions; field of view, focal length, or resolution of camera(s) 142 (142a and 142b are illustrated); or other constraints. A distance 324 between the frame member 326 and the scanning location 208 may be 622 millimeters, although this distance may similarly be varied. A total range of movement of the camera(s) 142a and 142b may extend fully or partially along the frame member 326, such as a total distance 328 of 1110 millimeters, though other dimensions are possible, as noted above. For instance, camera 142a is illustrated positioned at a distance 330 of 512 millimeters off center from the scanning location 208.

Returning to FIG. 3A, in the depicted example, two 3D or stereoscopic cameras 142 are illustrated. For example, a camera 142 may be a Zivid Two M70™ camera, which is a 3D camera that may be used to capture the scene with an item (e.g., of a given SKU) held by a robotic arm 140. Two of these cameras 142 may be used to create a more accurate picture and capture the scene from multiple possible angles. In some implementations, a single camera 142 may be used to capture an image of an item, the item may be rotated to capture it from multiple angles, or three or more cameras 142 may be used. Although, the cameras 142 are illustrated as being 3D or stereoscopic and positioned with the lenses offset vertically, they may be different types of cameras, positioned horizontally, or otherwise.

A robotic arm 140 (not shown in FIGS. 3A-3D) may be positioned adjacent to the station 302 to position an item above a chute 308 (e.g., at a scanning location 208) and/or drop an item through the chute 308. The robotic arm 140 may be an off the shelf or dedicated robotic arm 140, a humanoid robot, or other device (e.g., a robotic crane, conveyor, or diverter) that can automatedly move items in response to instructions or signals from a computing device. For instance, a robotic arm 140 may include an off the shelf industrial arm (such as provided by RightHand Robotics™ Vention™, or Universal Robots™) mounted to a chassis with a gripper or suction cup for grasping items. In some implementations, the robotic arm 140 may include additional or separate vision and machine learning software or smart grippers that provide feedback on grasp success.

Other devices may also be present in, near, or associated with the station 302. For instance, the station 302 may have a computing device controlling its operations (e.g., an equipment controller 110 or other computer), receiving data from the cameras 142, etc. The picking station 302 may also include additional off the shelf items, such as cameras (e.g., an Intel RealSense™ camera, etc.), power distribution units, CPUs, safety control units, emergency stop buttons, human-machine interface devices, pneumatic panels, enclosures, or other mechanisms.

FIG. 3C illustrates a partial front view, and FIG. 3D illustrates a partial side view of a chute 308, frame member 326, and cameras 142a and 142b. Other portions of the station 302 are omitted for illustration. FIGS. 3C and 3D illustrate a relative height of the camera(s) 142 to a chute 308 and a scanning location 208, although other implementations are possible and contemplated herein. For example, as illustrated, a robotic arm 140 (not shown) may position an item directly above the chute 308 to be scanned by the camera(s) 142. As noted elsewhere herein, the scan may be performed while the item is held by the arm 140, when the item is picked up, or when the arm 140 drops the item. If the item is identified when dropped, the detection application 622 may flag the item or carton, etc., to be checked by a quality control agent or device.

Although dimensions, angles, and configurations are provided, other implementations are possible and contemplated herein.

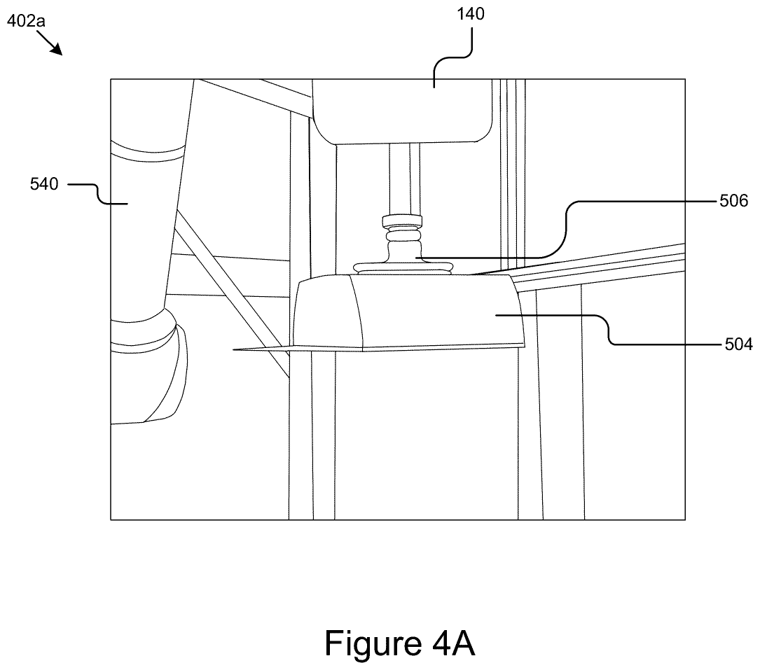

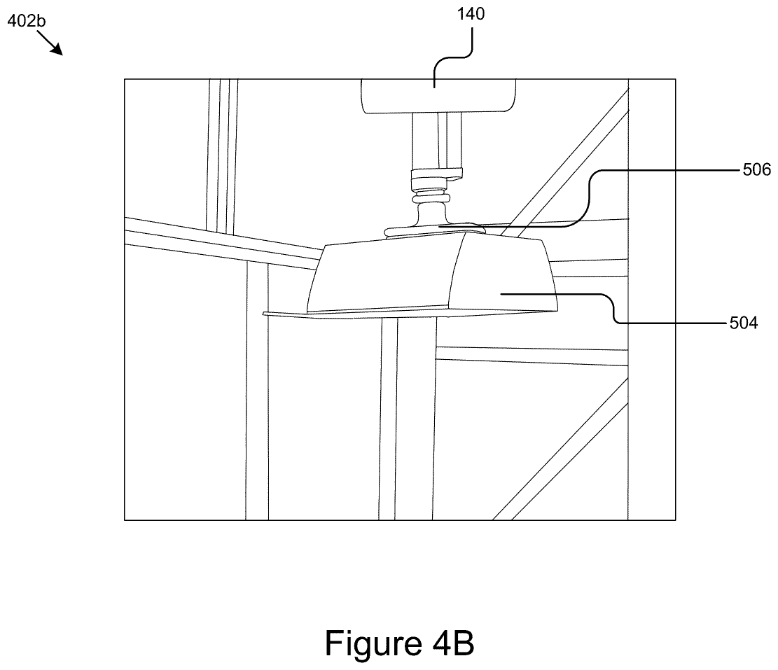

FIGS. 4A and 4B illustrate two images 402a and 402b, which may represent views of a left camera 142a and a right camera 142b respectively. While two-dimensional images are illustrated, stereoscopic or three-dimensional images or pixel maps may be additionally or alternatively be used. For instance, a robotic arm 140 with a suction cup 506 may pick up an item 504 (e.g., an ink cartridge box is shown) and hold it at a scanning location so that images can be captured of it by both cameras 142 from different angles. As described in further detail below, the cameras 142 may filter out a context of the item 504 from image data, estimate item dimensions, and match the item dimensions against a database of known items and item dimensions. A portion 540 of a robotic arm 140 is also visible in the image 402a, but, as noted, it may be excluded or ignored by the detection application 622.

As shown in the examples of FIGS. 4A and 4B, varying or inconsistent backgrounds may be behind the item. However, the techniques, including the cameras, configurations, and operations described herein allow the item to be identified even with these imperfect backgrounds. It should also be noted that, depending on the background, further improving the lighting or background may also improve item recognition accuracy.

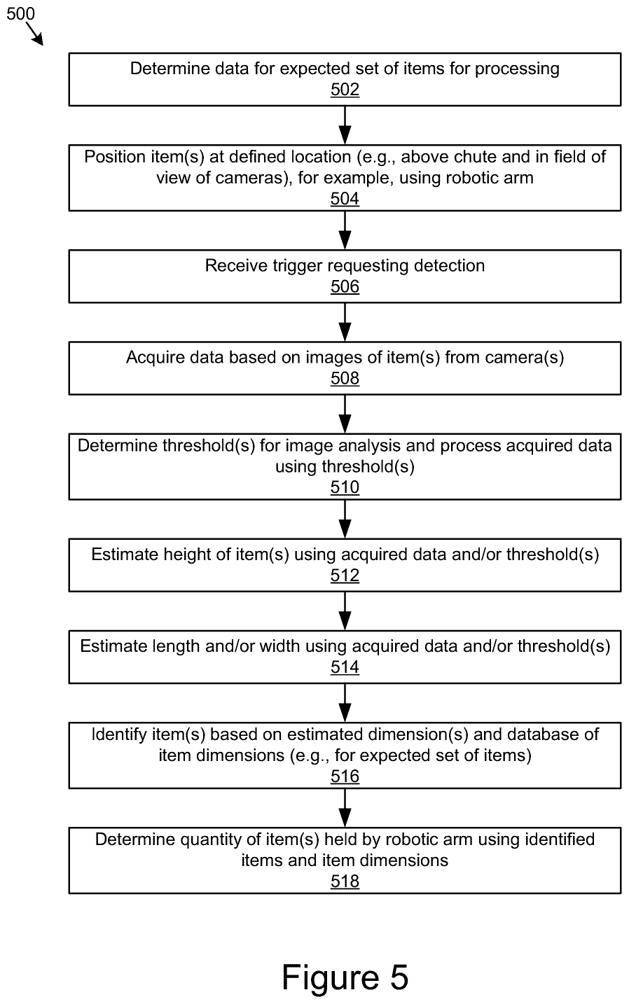

FIG. 5 is a flowchart of an example method 500 for item identification and/or multi-item detection, for example using the systems, operations, features, and technologies described herein. The example operations described in reference to FIG. 5 may be used with components and features described throughout this description. It should be noted that the operations of the method 500 may be used interchangeably or with the other operations and features used herein. Furthermore, it should be noted that operations of the method 500 and of this description may be augmented, reordered, omitted, or modified while still using technologies described in this disclosure. It should be noted that although the operations of the method 500 are described as being performed by the detection application 622 (e.g., executed on a WES 102 or equipment controller 110), other implementations are possible. For instance, they may be performed on or by other devices, such as those of the system 100.

In some implementations, the operations of the method 500 may determine dimensional estimations over 3D images received from the camera(s) 142, for example, upon receiving a trigger message indicating that the item is located at a designated location. The estimation may be performed over images from both camera(s) 142, for example, where a software trigger is received and, in response, data is acquired using the camera(s) 142. The data from the images may be filtered using static or dynamic thresholds. The height, width, length, shape, or other attributes may be estimated. In some instances, the estimates may be determined separately for the image from each camera 142 and then integrated into a single estimated representation of an item.

As noted above, previous solutions failed in a number of aspects. For instance, typically, using 3D vision requires too much time for an automated fulfillment center, but the methods described herein, for example, may identify items substantially quicker. Additionally, the technologies described herein may be robust, for instance, to be able to identify items and/or dimensions even for items that are wobbling, have different lighting conditions, or different background images. Similarly, previous solutions required a static background, static lighting, or static item type, whereas the operations described herein may identify an item from among thousands of items in a changing environment.

As described in the operations herein, an image may be captured by a camera 142, which image may be a collection of pixels. The detection application 622 may filter out the unwanted aspects of the image to target the specific area of the gripper (e.g., of a robotic arm 140). For instance, the application may use a focal length, depth, width, or height range to focus on a defined (e.g., in software) scanning area 208. In some instances, the portion of the data from the image that represents the gripper may also be filtered out (e.g., as its position and dimensions may be programmed into the detection application 622, which may position the gripper and/or ignore it during processing).

Accordingly, data for an item, such as a point cloud (e.g., in two or three dimensions) from the perspective of a camera 142 may be determined. In some implementations, similar data from the second camera 142 may also be determined from a second angle.

In some implementations, common data points may be matched between the data (e.g., the point clouds) from the two images to determine an overall shape/dimensions of the item. For instance, the detection application 622 may determine major or exterior points in space within a threshold distance or based on an expected angle (e.g., based on the relative angles of the cameras 142) of each other to build a more accurate image of the item.

In some implementations, additionally, or alternatively, the detection application 622 may use the point cloud from the image(s) to estimate one or more dimensions, such as a height, width, depth, and/or volume. The data from each camera 142 may be combined to estimate the dimensions or the data from each camera 142 may be used to estimate the dimensions, which may then be averaged, combined, checked against each other, or otherwise used to determine final dimensions.

The application may then match the point cloud, vector(s), or dimensions against a database of one or more items to identify the item and/or whether there are multiple of any expected items. Accordingly, it can be determined what item is handled (e.g., by the robotic arm 140), how many of said item are handled, or other data. Additionally, the detection application 622 may use other features, colors, etc., in its determination. These and other implementations are described elsewhere herein; although, it should be noted that the implementations are provided as examples and that other implementations are possible and contemplated herein.

In some implementations, at 502, the detection application 622 may determine data for an expected set of items for processing. For instance, a data file may describe a set(s) of items, which may have one or multiple item types (e.g., SKUs), may be received in a fulfillment center or location therein, such as on a pallet, conveyor, tote/mobile storage unit, or otherwise. For example, a specified tote or mobile storage unit containing items may be transported (e.g., by a conveyor, AGV114, or otherwise) to a station with a robotic arm 140, which picks an item from the tote. Because the items in the tote are known (e.g., one or more SKUs and/or a plurality of the same SKU may be in the tote), the set of data processed by the detection application 622 may be reduced in order to increase accuracy and processing speed. For instance, the dimensions or other data determined by the camera(s) 142 may be compared against the most-likely candidate of the items in the set of items expected to be received. In instances where it matches none of the expected items, the detection application 622 may determine that multiple items or an incorrect item was picked, as noted in further detail below.

The data file(s)/table(s) for the item(s) in the set may include, as noted above, dimension(s), shape(s), and/or identification information, although other data or attributes is possible and contemplated. The data file may be retrieved or accessed via the data store 120.

In some implementations, at 504, the detection application 622 may position one or more items at a defined location (e.g., at a scanning location 208 above a chute 308 and in a field of view of camera(s) 142), for example, using a robotic arm 140.

The system 100 may transport the set of items to the station by one or more conveyance devices. For example, a tote containing items may be moved to a delivery area of a picking station 302 by rollers, an AGV 114, a conveyor belt 240, a human agent, or other means, as noted above.

The detection application 622 or WMS 104 may instruct a robotic arm 140 or other device to move the item(s) from a conveyance device(s) to a scanning area 208. The robotic arm 140 or other device may attempt to move one item or multiple items at a time.

For example, the system (e.g., via the equipment controller 110) may instruct a robotic arm 140 to retrieve an item from a certain tote (e.g., at a defined location and/or where multiple totes or conveyance devices are at the station), grasp the item with a robotic hand or suction cup, articulate the item to/above the assigned chute 308, which may be a scanning area 208, and may hold the item at the location until its identity and/or quantity are determined by the detection application 622. For instance, the WMS 104 may issue an instruction to move one or more items from a source location to a target location, and a computing device (e.g., an equipment controller 110) at the station may determine and execute operations by the robotic arm 140 to move the item(s).

As described in additional detail elsewhere herein, in some implementations, regardless of the identification of a different or multiple items, the robotic arm 140 may place or drop the item at an item receiving area (e.g., in a shipping carton on a conveyor adjacent to the robotic arm 140), in which instance, the detection application 622 may flag the item, pick, carton, etc., as potentially including a mispicked item and another component (e.g., a human interface system 108 may notify an agent to check the pick. In other implementations, upon the detection application 622 determining that a mispick has been performed (e.g., either an incorrect item or quantity thereof), the robotic arm 140 may move the item(s) back to the location (e.g., the tote or delivery area) from which it was retrieved and replace it. The robotic arm 140 may then attempt to pick the correct item(s) again. In some cases, if the detection and/or pick operation fails a defined number of times, a message may be sent requesting human assistance via the human interface system 108 or the pick/carton may be tagged/flagged in an associated file to receive a quality assurance check.

In some implementations, at 506, the detection application 622 may receive a trigger requesting detection or analysis of the item(s). For example, while the trigger may be any condition, it may be a software trigger issued to the detection application 622 or by it indicating that the item is at a scanning area. For instance, the software trigger may be based on a robotic arm 140 positioning the object at a defined scanning area (e.g., the middle of the focal point) for data acquisition. In another implementation, the trigger may be a defined time, defined position of an item, or otherwise.

In some implementations, at 508, the detection application 622 may acquire data from the camera(s) 142 based on images of the item(s). For instance, the detection application 622 may instruct the camera(s) 142 to capture an image and it may receive the data from the camera(s) 142 for the image. Where multiple cameras 142 are used, in some implementations, the detection application 622 may associate the respective image with the respective camera 142, so that the angle information may be used to match data between the images during processing.

In some implementations, the camera(s) 142 may be 3D cameras, such as stereoscopic cameras, but they may also be lidar sensors, 2D cameras, cameras with time-of-flight sensors, and/or otherwise, as noted elsewhere herein.

In some implementations, at 510, the detection application 622 may determine one or more thresholds for image analysis and may process acquired data using the threshold(s). For instance, filtering using defined or determined thresholds may improve the ability of the technology to be used with various backgrounds, surroundings, lighting conditions, or otherwise. For instance, if there is an object or occlusion, such as dust or otherwise that is on a camera 142, it may be automatically filtered out.

For example, where a distance between a camera(s) 142 and a scanning area 208 is 1000 millimeters, a length is known. In some instances, dimensions of the item that are expected, such as a maximum range of dimensions of the determined set of items, may be used to determine an outermost possible or likely location of the item in the scanning area, which may be set as the threshold for the scan. Based on the threshold, the detection application 622 may exclude any data, such as data of a 3D point cloud outside that threshold area in order to avoid processing a background object or otherwise. Accordingly, a maximum scene for an image or resulting data set may be determined using these boundaries (whether static or dynamic for the expected set of items), which may include a minimum and/or maximum boundary. This filter boundary may dictate that any detected object should be within the expected boundary and may exclude anything outside of the boundary. If an object is detected outside of the boundary, the detection application 622 may ignore it, determine that a mispick occurred, or issue an error alert message to another component of the system 100.

In some implementations, this boundary may be used for image processing to build robustness. the boundary may also be used to determine if multiple of an item are picked (e.g., and extend outside a boundary), if an incorrect item is picked, or otherwise, as noted below. Similarly, by filtering out unexpected data (e.g., at unexpected locations), glare, dust, or other image anomalies may be ignored or removed from processing.

Accordingly, the detection application 622 may filter the image around the object and filter it from the background. The thresholds/boundaries may be statically set or may be dynamic for a set of items (whether of a single or multiple SKUs). The 3D boundary around the object may change in every image, for each pick of an item, for each set of items, for each placement of the picking station 302, or otherwise.

In some implementations, the thresholding may be a static value set, for example, based on items processed by a certain station, items that fit through a certain chute 308, in a shipping carton, or otherwise, such as a 100×100×100 millimeter cube.

In some implementations, at 512, the detection application 622 may estimate a height of the item(s) using the acquired data and/or threshold(s). The detection application 622 may know the position (e.g., it may be a defined parameter at set up of the station 302) of the camera(s) 142 relative to a scanning area 208 or to a robotic arm 140 (e.g., a defined value in programming, determined based on a known size or position of the robotic arm 140, etc.). The detection application 622 may use the distance and associated angles to calculate a quantity of pixels that are occupied or occluded by an item. For implementations where the camera(s) 142 is a 3D camera, it may provide a depth of how far points of an object are from the camera 142, so, separately or in combination with pixel data or other data from the camera 142, the dimensions and/or shape of the object may be determined (e.g., by counting pixels, determining an angular field of view, etc.)

Accordingly, for example, based on a known and/or determined distance from the camera(s) 142 to an object and the vertical quantity of pixels occupied by the object (e.g., by filtering the data as noted above), an item's height may be estimated.

In some implementations, at 514, the detection application 622 may estimate a length and/or width using the acquired data and/or the threshold(s). Similar to the height estimation, a width in pixels, shape in a point cloud, or other data may be used to determine an estimated width and/or depth. For instance, in some implementations, a point cloud of occupied positions may be determined from camera data from the 3D camera 142.

In some implementations, the data sets from each of the first and second cameras 142 may be stitched together to form a single representation of an item. For instance, the detection application 622 may use clustering, minimum/maximum distances, expected angles between images, or other means to determine which points match between the data from the first and second cameras 142. For example, the detection application 622 may overlay the two representations, match their points, and use the remaining points to further fill out the representation of the item(s).

The dimensions of a scanned item may then be determined by the detection application 622, for instance, by identifying a general shape of the item, a maximum dimension in any direction, an estimated volume, or otherwise. Depending on camera resolution and processing parameters, these operations may yield an accuracy that allows objects of less than one millimeter to be detected.

The detection application 622 may transmit the dimension and/or shape data to various other applications or systems (e.g., to a WES 102 or WMS 104) or it may process them directly.

In some implementations, at 516, the detection application 622 may identify the one or more items based on the estimated dimensions (e.g., for an expected set of items), and/or at 518, the detection application 622 may determine a quantity of the one or more items scanned using the identified items and/or the item dimensions. For example, the detection application 622 may match the determined dimension(s) against a database of items and their associated dimensions to identify an item (e.g., with matching dimensions) or identify if the dimensions exceed (e.g., by a threshold amount) the expected dimensions of the item or items in the set.

For example, where an item is known (e.g., as noted at 502 and/or 504), the detection application 622 may determine whether the measured dimensions exceed the known dimensions (e.g., based on a file describing the known item). If the measured dimensions exceed the known/expected dimensions, the detection application 622 may determine that multiple items have been picked instead of a single item. In some implementations, the detection application 622 or other component may allow the robotic arm 140 to drop the item(s) into a carton even with the error, but it may flag the carton in an associated file to be manually double checked by a human. In other implementations, the robotic arm 140 may be instructed to return and re-pick the item from its source (e.g., a specified delivery area 204).

It should be noted that because items may be picked up and scanned in various orientations, the detection application 622 may digitally reorient the object/dimensions to one or both of the measured dimensions and expected dimensions to ensure that they are consistent (e.g., by orienting a longest, middle, and shortest dimension to be consistent before comparing them). In other implementations, various orientations may be attempted when matching until one is matched or until the orientation options are exhausted.

In some implementations, at 518, the detection application 622 may determine a quantity of the one or more items scanned using the identified item(s) (e.g., at 502 and/or 516) and/or the item dimensions. For instance, the detection application 622 may determine whether the detected dimension(s) match those of an item (e.g., in the set or in a database), whether it/they match a multiple of an item's dimension(s), or whether it/they matches none of the expected dimensions (e.g., if two different items are picked up).

Accordingly, the detection application 622 may match the detected dimensions against a database of items (e.g., the set of items) to determine whether it includes a single one of the items. In some instances, if the detected dimensions do not match any of the expected items, the detection application 622 may instruct the robotic arm 140 to replace and then repick the item, for example, assuming that the item(s) originally picked included multiple items. In other instances, the detection application 622 may determine that the detected dimensions are two or three times larger than the expected dimensions of an item, in which instances, the detection application 622 may determine that multiple items were picked. If the picked quantity does not match the desired quantity (e.g., for an order/carton), the robotic arm 140 may replace the items and repick them. If the detection application 622 is, instead of filling orders or sorting items, counting items (e.g., inventorying the items), the detection application 622 may iterate the quantity counted by the determined amount, or it may replace, repick, and recount the single item.

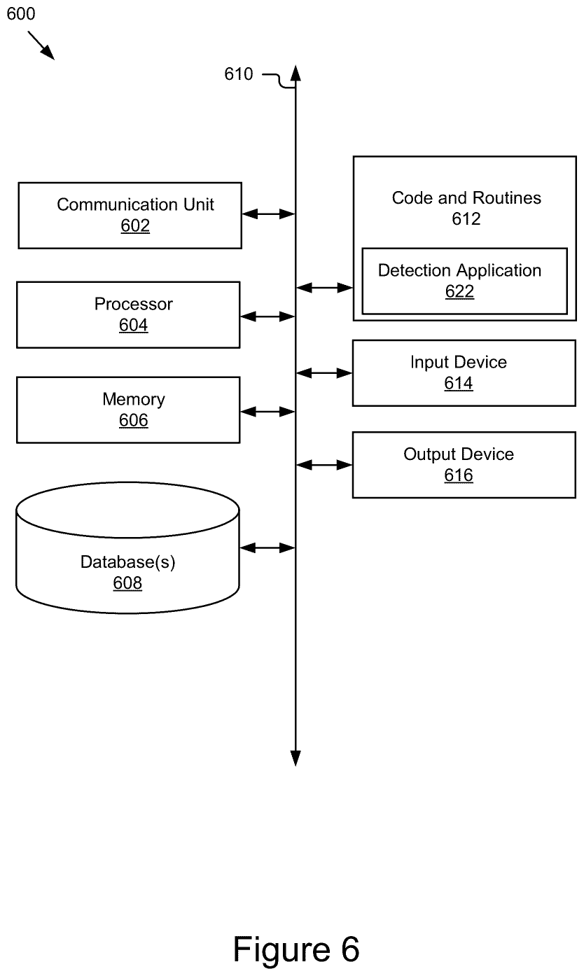

FIG. 6 is a block diagram illustrating an example computing system 600. The example computing system 600 may correspond to a WES 102, a WMS 104, a dispatch system 106, a human interface system 108, equipment controller(s) 110, REX server 118, a client device, a computing device of a picking station 302, and/or other component of the system 100, for example.

The detection application 622 and/or code and routines 612 may include computer logic executable by the processor 604 on a computing system 600 to provide for the functionality described in reference to one or more of the components of the system 100. For instance, in some implementations, the code and routines may include one or more of the components of the WES 102 or equipment controller(s) 110.

As depicted, the computing system 600 may include a processor 604, a memory 606, a communication unit 602, an output device 616, an input device 614, and database(s) 608, which may be communicatively coupled by a communication bus 610. The computing system 600 depicted in FIG. 6 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing system 600 may include various operating systems, sensors, additional processors, and other physical configurations. Although, for purposes of clarity, FIG. 6 only shows a single processor 604, memory 606, communication unit 602, etc., it should be understood that the computing system 600 may include a plurality of one or more of these components.

The processor 604 may execute software instructions by performing various input, logical, and/or mathematical operations. The processor 604 may have various computing architectures to process data signals including, for example, a complex instruction set computer (CISC) architecture, a reduced instruction set computer (RISC) architecture, and/or an architecture implementing a combination of instruction sets. The processor 604 may be physical and/or virtual, and it may include a single core or plurality of processing units and/or cores. In some implementations, the processor 604 may be capable of generating and providing electronic display signals to a display device, supporting the display of images, capturing and transmitting images, performing complex tasks including various types of feature extraction and sampling, etc. In some implementations, the processor 604 may be coupled to the memory 606 via the bus 610 to access data and instructions therefrom and store data therein. The bus 610 may couple the processor 604 to the other components of the computing system 600 including, for example, the memory 606, the communication unit 602, the input device 614, the output device 616, and the database(s) 608.

The memory 606 may store and provide access to data to the other components of the computing system 600. The memory 606 may be included in a single computing device or a plurality of computing devices. In some implementations, the memory 606 may store instructions and/or data that may be executed by the processor 604. For example, the memory 606 may store the code and routines 612. The memory 606 is also capable of storing other instructions and data, including, for example, an operating system, hardware drivers, other software applications, databases, etc. The memory 606 may be coupled to the bus 610 for communication with the processor 604 and the other components of computing system 600.

The memory 606 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 604. In some implementations, the memory 606 may include one or more of volatile memory and non-volatile memory (e.g., RAM, ROM, hard disk, optical disk, etc.). It should be understood that the memory 606 may be a single device or may include multiple types of devices and configurations.

The bus 610 can include a communication bus for transferring data between components of a computing device or between computing devices, a network bus system including a network or portions thereof, a processor mesh, a combination thereof, etc. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 602 may include one or more interface devices (I/F) for wired and wireless connectivity among the components of the system 100. For instance, the communication unit 602 may include various types of connectivity and interface options. The communication unit 602 may be coupled to the other components of the computing system 600 via the bus 610. The communication unit 602 may be electronically communicatively coupled to a network (e.g., wiredly, wirelessly, etc.). In some implementations, the communication unit 602 can link the processor 604 to a network, which may in turn be coupled to other processing systems. The communication unit 602 can provide other connections to a network and to other entities of the system 100 using various standard communication protocols.

The input device 614 may include any device for inputting information into the computing system 600. In some implementations, the input device 614 may include one or more peripheral devices. For example, the input device 614 may include a keyboard, a pointing device, microphone, an image/video capture device (e.g., camera 142), a touchscreen display integrated with the output device 616, optical scanner, barcode reader, QR™ code reader, RFID (radio-frequency identification) tag reader, etc.

The output device 616 may be any device capable of outputting information from the computing system 600. The output device 616 may include one or more of a display (LCD, OLED, etc.), a printer, a 3D printer, a haptic device, audio reproduction device, touch-screen display, etc. In some implementations, the output device is a display which may display electronic images and data output by the computing system 600 for presentation to a user, such as a picker or associate in the order fulfillment center. In some implementations, the computing system 600 may include a graphics adapter (not shown) for rendering and outputting the images and data for presentation on output device 616. The graphics adapter (not shown) may be a separate processing device including a separate processor and memory (not shown) or may be integrated with the processor 604 and memory 606.

The database(s) are information source(s) for storing and providing access to data. The data stored by the database(s) 608 may be organized and queried using various criteria including any type of data stored by them, such as the data in the data store 120 and other data discussed herein. The database(s) 608 may include file systems, data tables, documents, databases, or other organized collections of data. Examples of the types of data stored by the database(s) 608 may include the data described herein, for example, in reference to the data store 120 or throughout the description.

The database(s) 608 may be included in the computing system 600 or in another computing system and/or storage system distinct from but coupled to or accessible by the computing system 600. The database(s) 608 can include one or more non-transitory computer-readable mediums for storing the data. In some implementations, the database(s) 608 may be incorporated with the memory 606 or may be distinct therefrom. In some implementations, the database(s) 608 may store data associated with a database management system (DBMS) operable on the computing system 600. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

It should be noted that the components described herein may be further delineated or changed without departing from the techniques described herein. For example, the processes described throughout this disclosure may be performed by fewer, additional, or different components.

It should be understood that the methods described herein are provided by way of example, and that variations and combinations of these methods, as well as other methods, are contemplated. For example, in some implementations, at least a portion of one or more of the methods represent various segments of one or more larger methods and may be concatenated or various steps of these methods may be combined to produce other methods which are encompassed by the present disclosure. Additionally, it should be understood that various operations in the methods are iterative, and thus repeated as many times as necessary generate the results described herein. Further the ordering of the operations in the methods is provided by way of example and it should be understood that various operations may occur earlier and/or later in the method without departing from the scope thereof.

In the above description, for purposes of explanation, numerous specific details are set forth in order to provide a thorough understanding of the present disclosure. However, it should be understood that the technology described herein can be practiced without these specific details in various cases. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms such as “processing,” “computing,” “calculating,” “determining,” “displaying,” or the like, refer to the action and methods of a computer system that manipulates and transforms data represented as physical (electronic) quantities within the computer system's registers and memories into other data similarly represented as physical quantities within the computer system memories or registers or other such information storage, transmission or display devices.

A data processing system suitable for storing and/or executing program code, such as the computing system and/or devices discussed herein, may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices can be coupled to the system either directly or through intervening I/O controllers. The data processing system may include an apparatus may be specially constructed for the required purposes, or it may comprise a general-purpose computer selectively activated or reconfigured by a computer program stored in the computer.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects may not be mandatory or significant, and the mechanisms that implement the specification or its features may have different names, divisions, and/or formats.

Furthermore, the modules, routines, features, attributes, methodologies, and other aspects of the disclosure can be implemented as software, hardware, firmware, or any combination of the foregoing. The technology can also take the form of a computer program product accessible from a computer-usable or computer-readable medium providing program code for use by or in connection with a computer or any instruction execution system. Wherever a component, an example of which is a module or engine, of the specification is implemented as software, the component can be implemented as a standalone program, as part of a larger program, as a plurality of separate programs, as a statically or dynamically linked library, as a kernel loadable module, as firmware, as resident software, as microcode, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A computer-implemented method comprising:
capturing, by one or more processors and using one or more cameras, image data of one or more items at a scanning area;
determining, by the one or more processors, one or more thresholds for the image data using one or more first dimensions of a set of items;
filtering, by the one or more processors, the image data using the one or more thresholds;
estimating, by the one or more processors, one or more second dimensions of the one or more items based on the filtered image data; and
identifying, by the one or more processors, a first item from among the one or more items by comparing the estimated one or more second dimensions of the one or more items with the one or more first dimensions of the set of items.

2. The computer-implemented method of claim 1, further comprising:
determining, by the one or more processors, that the one or more items include a plurality of items based on the estimated one or more second dimensions and the one or more first dimensions.

3. The computer-implemented method of claim 1, further comprising:
receiving, by the one or more processors, a software trigger, the software trigger indicating when a robotic arm is holding the one or more items at the scanning area; and
responsive to receiving the software trigger, capturing the image data by a plurality of cameras, each of the plurality of cameras being placed at a different angle to the scanning area.

4. The computer-implemented method of claim 1, further comprising:
retrieving, by the one or more processors using a robotic arm, the one or more items from a mobile storage unit, the mobile storage unit holding the set of items; and
positioning, by the one or more processors using the robotic arm, the one or more items at the scanning area.

5. The computer-implemented method of claim 1, further comprising:
instructing, by the one or more processors, a robotic arm to retrieve a defined item of the set of items from a mobile storage unit;
determining, by the one or more processors, that the first item does not match the defined item; and
instructing, by the one or more processors, the robotic arm to replace the first item in the mobile storage unit.

6. The computer-implemented method of claim 1, further comprising:
instructing, by the one or more processors, a robotic arm to retrieve a defined item of the set of items from a mobile storage unit;
determining, by the one or more processors, that the first item does match the defined item; and
instructing, by the one or more processors, the robotic arm to release the first item to a shipping carton.

7. The computer-implemented method of claim 6, further comprising:
transporting, by the one or more processors using an automated guided vehicle, the mobile storage unit holding the set of items to an item delivery area associated with the one or more cameras; and
determining the one or more first dimensions describing the set of items based on an identity of the mobile storage unit.

8. The computer-implemented method of claim 1, wherein capturing the image data of the one or more items at the scanning area includes:
capturing two images from two different angles using the one or more cameras.

9. The computer-implemented method of claim 8, wherein estimating the one or more second dimensions of the one or more items includes:
generating, by the one or more processors, a point cloud using the two images, each of the two images being captured using a stereoscopic camera.

10. The computer-implemented method of claim 1, wherein filtering the image data using the one or more thresholds includes:
excluding, by the one or more processors, one or more objects in the image data based on the one or more objects being external to the scanning area of the image data defined by the one or more thresholds.

11. A system comprising:
a robotic arm adapted to hold one or more items at a defined scanning area;
a frame holding two or more cameras at a defined angle to the defined scanning area; and
one or more processors executing instructions that cause the one or more processors to perform operations including:
processing image data captured using the two or more cameras; and
performing one or more of determining an identity of the one or more items and determining whether the one or more items include a plurality of items.

12. The system of claim 11, wherein:
each of the two or more cameras include a stereoscopic camera; and
the image data includes at least two stereoscopic images.

13. The system of claim 11, wherein the frame includes one or more horizontal members that allow the two or more cameras to be adjusted along two horizontal axes.

14. The system of claim 11, further comprising:
a chute below the defined scanning area, the robotic arm being configured to drop the one or more items through the chute.

15. The system of claim 14, further comprising:
an item delivery area from which the robotic arm is configured to grasp the one or more items; and
an item receiving area to which the robotic arm is configured to place the one or more items, the one or more items passing through the chute to the item receiving area responsive to the one or more processors determining that that the one or more items include a single item.

16. The system of claim 11, wherein the operations further include:
determining, by the one or more processors, one or more thresholds for the image data using one or more first dimensions of a defined set of items; and
filtering, by the one or more processors, the image data using the one or more thresholds.

17. The system of claim 16, wherein the operations further include:
estimating, by the one or more processors, one or more second dimensions of the one or more items based on the filtered image data; and
identifying, by the one or more processors, a first item from among the one or more items by comparing the estimated one or more second dimensions of the one or more items with the one or more first dimensions of the defined set of items.

18. The system of claim 17, wherein the operations further include:
determining, by the one or more processors, that the one or more items include the plurality of items based on the estimated one or more second dimensions and the one or more first dimensions.

19. The system of claim 11, wherein the operations further include:
retrieving, by the one or more processors using the robotic arm, the one or more items from a mobile storage unit, the mobile storage unit holding a set of items; and
positioning, by the one or more processors using the robotic arm, the one or more items at the defined scanning area.

20. The system of claim 11, wherein the operations further include:
instructing, by the one or more processors, the robotic arm to retrieve a defined item of a set of items from a mobile storage unit;
determining, by the one or more processors, that the one or more items do not match the defined item; and
instructing, by the one or more processors, the robotic arm to replace the one or more items in the mobile storage unit.

21. A method comprising:
positioning, by a robotic arm, one or more items at a defined location;
capturing three-dimensional image data of the one or more items at the defined location using a plurality of stereoscopic cameras;
determining one or more thresholds for image processing using expected dimensions of the one or more items;
applying filtering using the one or more thresholds to the three-dimensional image data;
estimating dimensions of the one or more items using the filtered three-dimensional image data; and
determining that the one or more items include a plurality of items based on the estimated dimensions and the expected dimensions of the one or more items.
